(19) United States
(12) Patent Application Publication
(10) Pub. No.: US 2009/0271566 A1
(43) Pub. Date: Oct. 29, 2009

(54) METHOD FOR CONFIGURING OR RE-CONFIGURING PROGRAMMABLE DEVICE AND APPARATUS ASSOCIATED THEREWITH

(75) Inventor: Alan A. Arman, Powell, OH (US)

Correspondence Address: CALFEE HALTER & GRISWOLD, LLP, 800 SUPERIOR AVENUE, SUITE 1400, CLEVELAND, OH, 44114, US

(73) Assignee: Boxicom, Inc. (dba 3X Systems), Columbus, OH (US)

(21) Appl. No.: 12/429,617

(22) Filed: Apr. 24, 2009

Related U.S. Application Data
(60) Provisional application No. 61/047,584, filed on Apr. 24, 2008.

(51) Int. Cl. G06F 12/00; G06F 12/02

(52) U.S. Cl. 711/103; 711/E12.001; 711/E12.008

(57) ABSTRACT

A method of configuring a programmable device may include connecting an electronic storage medium to a configuration system with user-friendly input/output capabilities to establish configuration information for the programmable device, which may have limited input/output capabilities. The configuration information may be applied to the programmable device when the electronic storage medium is connected to the programmable device. Additional programmable devices may be configured when connected to the electronic storage medium. Further embodiments of the method and apparatus to provide the programmable device configuration service are also provided.

### CROSS REFERENCE TO RELATED APPLICATIONS

This application claims the benefit of U.S. Provisional Application No. 61/047,584, filed Apr. 24, 2008, which is hereby incorporated by reference.

### FIELD OF INVENTION

The present invention is in the field of programmable electronic devices.

### BACKGROUND

The present invention relates to configuring a programmable device. It finds particular application in conjunction with using an electronic storage medium to configuring the programmable device and will be described with particular reference thereto. It will be appreciated, however, that the invention is also amenable to other applications.

Many electronic devices are programmable and must be configured before they are operable in a desired manner. Configurations may include initial set-up parameters, parameter changes, firmware updates, software updates, functionality updates, etc. In many cases, the target device has limited input/output capabilities, resulting in a cumbersome configuration process. These devices may not have an easy way to interact with, program, and/or configure the device.

In particular, the initial configuration and set-up of the target device can be a difficult process when the target device lacks sufficient input/output capabilities. For example, setting up a wireless access point (target device) so that the Internet can be accessed wirelessly from various computers may require configuring the access point. The device may not be initially configured to function in the desired environment or in the manner that the user prefers. Typically, the user must configure the device to function as intended. For a wireless access point, the user may need to set up password protection, encryption, provide information about the network layout, etc. before the access point can function as intended. Not until after the access point is configured properly can other computers connect to the access point, and then through the access point, connect to the Internet.

As in the access point example, the initial set-up and configuration may be difficult due to the limited input/output capabilities of the access point. In some cases, the target device may need to be connected, for example, directly or over a network, to a configuration system, such as a computer, for configuration purposes. In this manner, the configuration system hosts the configuration process. Configuration system software may be provided to the user that allows the configuration system to discover the target device and may provide a user interface for configuration purposes. This traditional method requires the user to install software on the configuration system, somehow connect the target device to the configuration system, discover the target device using the configuration system, establish a configuration, and save the configuration to the target device directly from the configuration system. This process may have to be repeated for every target device.

The present invention provides a new and improved apparatus and method which addresses the above-referenced problems.

### SUMMARY

A method of providing a configuration to a programmable device, including connecting an electronic storage medium to a configuration system, establishing at least one configuration for at least one programmable device, storing the at least one configuration on the electronic storage medium, disconnecting the electronic storage medium from the configuration system, connecting the electronic storage medium to the at least one programmable device, and applying the at least one configuration from the electronic storage medium to the at least one programmable device, wherein the at least one programmable device remains operational and configured if the electronic storage medium remains connected to or is removed from the at least one programmable device after applying the at least one configuration.

A programmable device configuration system, including an electronic storage medium, a configuration system connectable to the electronic storage medium, and at least one programmable device connectable to the electronic storage medium, wherein the at least one programmable device requires the at least one configuration, and wherein the at least one configuration intended for the at least one programmable device is stored on the electronic storage medium.

A method of transferring a configuration from a configuration system to a programmable device, including connecting an electronic storage medium to the configuration system, determining at least one configuration for at least one programmable device, using a superior user interface of the configuration system relative to the programmable device, storing the at least one configuration on the electronic storage medium, disconnecting the electronic storage medium from the configuration system, connecting the electronic storage medium to the at least one programmable device, and applying the at least one configuration from the electronic storage medium to the at least one programmable device, wherein the at least one programmable device remains operational and configured if the electronic storage medium remains connected to or is removed from the at least one programmable device after applying the at least one configuration.

### DRAWINGS

These and other features, aspects, and advantages of the present invention will become better understood with regard to the accompanying drawings, following description, and appended claims.

FIG. 1 is a block diagram of an exemplary embodiment of a programmable device configuration system;

FIG. 2 is a flow chart of an exemplary embodiment of a process for providing a programmable device configuration service; and

FIG. 3 is a block drawing of an exemplary embodiment of a physical transport medium.

### DESCRIPTION

The following paragraphs include definitions of exemplary terms used within this disclosure. Except where noted otherwise, variants of all terms, including singular forms, plural forms, and other forms, fall within each exemplary term meaning. Except where noted otherwise, capitalized and non-capitalized forms of all terms fall within each meaning.

“Comprising,” “containing,” “having,” and “including,” as used herein, except where noted otherwise, are synonymous and open-ended. In other words, usage of any of these terms (or variants thereof) does not exclude one or more additional elements or method steps from being added in combination with one or more delineated elements or method steps.

“Computer communication,” as used herein includes, but is not limited to, a communication between two or more computer components and can be, for example, a network transfer, a file transfer, a data transfer, an applet transfer, an e-mail, a hypertext transfer protocol (HTTP) message, a datagram, an object transfer, a binary large object (BLOB) transfer, and so on. A computer communication can occur across, for example, a direct connection (e.g., Universal Serial Bus (USB) and FireWire (IEEE 1394) interfaces), a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, any other current or subsequent communication system, and so on.

“Computer component,” as used herein includes, but is not limited to, a computer-related entity, either hardware, firmware, software, a combination thereof, or software in execution. For example, a computer component can be, but is not limited to being, a processor, an object, an executable, a process running on a processor, a thread of execution, a program, a memory, and a computer. By way of illustration, both an application running on a server and the server can be computer components. One or more computer components can reside within a process or thread of execution and a computer component can be localized on one computer or distributed between two or more computers, components, or other devices.

“Configuration system,” as used herein includes, but is not limited to, an electronic device with superior input/output capabilities relative to a “target device.” For example, the configuration system could be a computer that offers a relatively large viewable screen, keyboard, and/or mouse.

“Operable connection” (or a connection by which entities are “operably connected”), as used herein includes, but is not limited to, a connection in which signals, physical communication flow, or logical communication flow may be sent or received. Usually, an operable connection includes a physical interface, an electrical interface, or a data interface, but an operable connection may include differing combinations of these or other types of connections sufficient to allow operable control.

“Or,” as used herein, except where noted otherwise, is inclusive, rather than exclusive. In other words, “or” is used to describe a list of alternative things in which one may choose one option or any combination of alternative options. For example, “A or B” means “A or B or both” and “A, B, or C” means “A, B, or C, in any combination or permutation.” If “or” is used to indicate an exclusive choice of alternatives or if there is any limitation on combinations of alternatives, the list of alternatives specifically indicates that choices are exclusive or that certain combinations are not included. For example, “A or B, but not both” is used to indicate use of an exclusive “or” condition. Similarly, “A, B, or C, but no combinations” and “A, B, or C, but not the combination of A, B, and C” are examples where certain combinations of alternatives are not included in the choices associated with the list.

“Physical transport medium,” as used herein includes, but is not limited to, an object or electronic device that can store information. In one embodiment, the physical transport medium would have full read/write capabilities. In another embodiment, the physical transport medium could operate using a write-once medium. For example, the physical transport medium could be a USB memory stick or writable compact disk (CD) medium. The physical transport medium shares at least one input/output interface with the “target device” and the “configuration system,” but the same input/output interface need not be used for both. The physical transport medium may have substantially inferior input/output capabilities when compared to the “target device” and the “configuration system.”

“Software,” as used herein includes, but is not limited to, one or more computer readable or executable instructions that cause a computer or another electronic device to perform functions, actions, or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, instructions stored in a memory, part of an operating system, or other types of executable instructions. It will be appreciated by one of ordinary skill in the art that the form of software is dependent on, for example, requirements of a desired application, the environment it runs on, or the desires of a designer/programmer or the like.

“Software component,” as used herein includes, but is not limited to, a collection of one or more computer readable or executable instructions that cause a computer or other electronic device to perform functions, actions or behave in a desired manner. The instructions may be embodied in various forms like routines, algorithms, modules, methods, threads, or programs. Software components may be implemented in a variety of executable or loadable forms including, but not limited to, a stand-alone program, a servelet, an applet, instructions stored in a memory, and the like. Software components can be embodied in a single computer component or can be distributed between computer components or other devices.

“Target device,” as used herein includes, but is not limited to, a programmable electronic device that requires configuration. The target device may have limited input/output capabilities. Input/output capabilities include, but are not limited to, for example, monitors, keyboards/keypads, mice, and network connections. Limited input/output capabilities, as used herein include, but are not limited to, input/output capabilities that are not present, that cannot be attached, that are not properly configured (and thus nonfunctional), or that present an inferior interface experience (such as a very small screen). Additionally, limited input/output capabilities could imply that the device cannot run or display the require configuration software, preventing input of or output of necessary configurations.

In one embodiment, the claimed programmable device configuration system uses a physical transport medium to easily configure programmable devices, including those with limited input/output capabilities. The physical transport medium can host software for both configuration and set-up and interfaces directly with the target device. The configuration information intended for the target device is established using the user-friendly input/output capabilities of the configuration system and subsequently transferred to the target device via the physical transport medium. In addition, the configuration information, once established, can be applied to any number of target devices without repeating the configuration set-up with the configuration system.

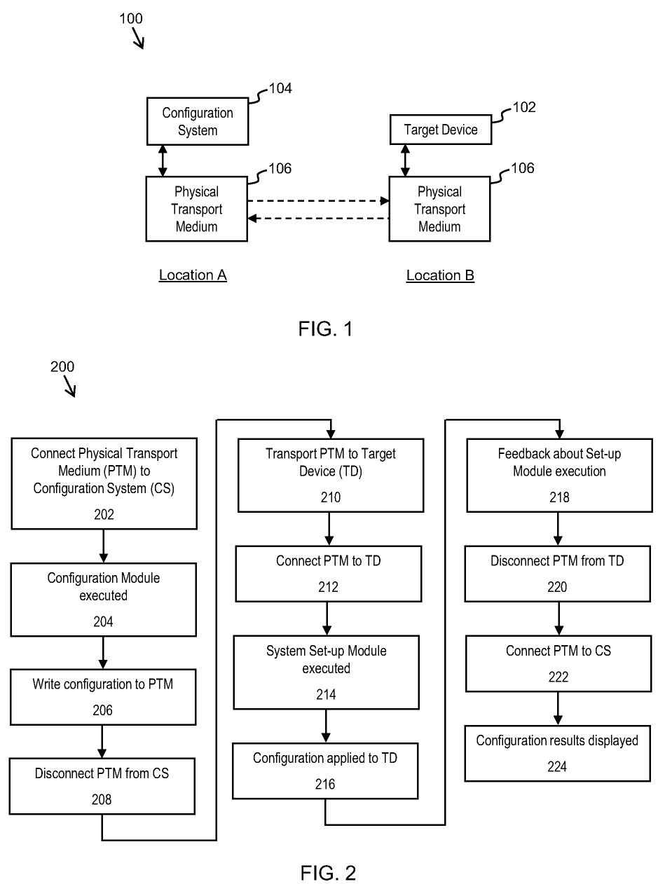

With reference to FIG. 1, an exemplary embodiment of the programmable device configuration system 100 includes a target device 102. The target device 102 may be a programmable electronic device with limited input/output capabilities, such as, for example, a network access point, firewall, network router, or thermostat. Typically, a target device 102 with limited input/output capabilities, for example, relatively small, non-functional, or nonexistent monitor, keyboard, software, or operable connections, would present challenges to the user during configuration. The programmable device configuration system 100 may alleviate problems encountered during configuration of the target device 102 by utilizing the relatively superior capabilities of a configuration system 104 and a physical transport medium 106. The configuration system 104 is an electronic device with superior input/output capabilities relative to the target device 102, allowing for easier establishment of configuration information intended for the target device 102. The physical transport medium 106 is an object or electronic device that stores and transports the configuration information intended for the target device 102. The programmable device configuration system 100 is distinguished from a process where the configuration system 104 is directly connected to the target device 102.

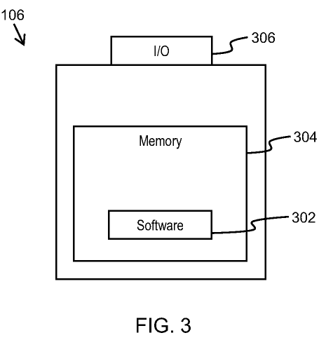

The programmable device configuration system 100 may also utilize various software components. The software components are comprised of various modules. The modules need not be distinguishable from each other; the term module simply implies that the functionality exists in a software application or component. In one embodiment, software used by the programmable device configuration system 100 initially resides on the physical transport medium 106 and may be subsequently shared (in part or whole) with the configuration system 104, target device 102, or any other computer, component, or device. In this manner, and with additional reference to FIG. 3, the physical transport medium 106 contains the necessary software 302, memory 304, and operable connectivity 306 required to easily configure the target device 102 without requiring another device to host the configuration process. While the physical transport medium 106 may utilize the input/output capabilities of the configuration system 104 as a user-friendly interface, the functionality of the programmable device configuration system 100 may reside solely on the physical transport medium 106. In another embodiment, the programmable device configuration system 100 may update the software from the Internet or other source, such as another computer, component, medium, or device.

A configuration module is a software application or component thereof that can be used to develop a configuration protocol for the target device 102. The configuration module may be stored (in part or whole) either on the configuration system 104 or on the physical transport medium 106. The configuration module establishes and stores configuration information on the physical transport medium 106. The configuration module may be executed automatically as a result of some action or may require specific user action to trigger its execution.

A system set-up module is a software application or component thereof that can be used to apply configuration information to the target device 102. The system set-up module may be stored (in part or whole) either on the physical transport medium 106 or on the target device 102. The system set-up module reads the configuration information from the physical transport medium 106 and transfers the configuration information to the target device 102. The system set-up module can either be executed automatically as a result of some action or may require specific user action to trigger its execution.

Additional modules may be present that can write the results of the system set-up module transfer to the physical transport medium 106, communicate the results of the system set-up module through input/output capabilities of the target device 102, accept additional configuration information through input/output capabilities of the target device 102, or display or communicate the results stored on the physical transport medium 106 to the user of the configuration system 104. Results may include, but are not limited to, the success or failure of the set-up module's execution or the state of the target device 102 before and/or after the set-up module was executed. These modules may either be executed automatically as a result of some action or may require specific user action to trigger their execution. These modules need not be distinguishable from one another, the configuration module, or the system set-up module.

With additional reference to FIG. 2, an exemplary embodiment of a process 200 for providing a programmable device configuration service is shown. The process may begin at 202 where the physical transport medium 106 is operably connected to the configuration system 104 (Location A in FIG. 1). At 204, the configuration module is executed and presents input/output capabilities to the user. For example, the input/output capabilities may be a command line program that accepts configuration information as parameters or a full graphical user interface (GUI) that allows the user to navigate screens and fields to set configuration parameters. The configuration module may read configuration information from or write configuration information to the physical transport medium 106 or other computer components, such as a hard drive or other storage medium. For example, a user may transfer preferred configuration information or parameters from the hard drive or transfer the last configuration from the physical transport medium 106 or another device that operated as a physical transport medium 106. At 206, the configuration module will write one or more configurations to the physical transport medium 106.

At 208, once the configuration information is written to the physical transport medium 106, the physical transport medium 106 may be disconnected from the configuration system 104. At 210, the physical transport medium 106 may be transported to the target device 102. At 212, the physical transport medium 106 is then operably connected to the target device 102 (Location B in FIG. 1). For example, in an embodiment where the physical transport medium 106 is a USB memory device and the configuration system 104 is a computer, the USB device is disconnected from the computer and subsequently connected to the target device 102.

At 214, once the physical transport medium 106 is connected to the target device 102, the system set-up module is executed (either automatically or as a result of a specific user action). At 216, the system set-up module may search for and/or attempt to apply one or more configurations to the target device 102. The process may allow the user to select from available configurations before applying a configuration to the target device 102. The user may also be able to designate certain configurations as primary or default configurations for use by particular and/or different target devices 102 or different versions of target devices 102. If the configuration on the target device 102 is determined to be a later or preferred configuration when compared to the configuration on the physical transport medium 106, the configuration may be transferred from the target device 102 to the physical transport medium 106. Synchronization of configurations may be completed automatically, or based on user actions.

In addition, at 218, other modules may provide feedback on the results of the system set-up module's execution. The feedback may include, but is not limited to, an audio feedback of the success or failure of the configuration process, writing the status of the target device 102 back to the physical transport medium 106, or indicating through audio, visual, or other communication means the state of the target device 102 or consequence of the configuration process. At 220, the physical transport medium 106 may be disconnected from the target device 102.

At 222, if results were written to the physical transport medium 106, and particularly in the case where a configuration failed to apply properly to the target device 102, the physical transport medium 106 may be connected to the configuration system 104 (Location A in FIG. 1), another system operating as a configuration system 104, or any system permitting output of the results data on the physical transport medium 106. At 224, the results of the configuration may be viewed by the user.

The user may repeat the process defined in the process 200 with the same physical transport medium 106 or another medium operating as the physical transport medium 106. For example, in an embodiment where the physical transport medium 106 is a USB memory device and the configuration system 104 is a computer, the USB device may be inserted back into the computer to view the results written to the USB device, and if desired, the process may be repeated with the same, different, or new configuration or set of configurations. Once the desired configuration or multiple configurations are established on the physical transport medium 106, the physical transport medium 106 may be connected to any number of target devices 102 without repeating the configuration module steps.

The software and/or physical transport medium 106 may also include security settings to control user access and configuration capabilities.

While the invention is described herein in conjunction with one or more exemplary embodiments, it is evident that many alternatives, modifications, and variations will be apparent to those skilled in the art. Accordingly, exemplary embodiments in the preceding description are intended to be illustrative, rather than limiting, of the spirit and scope of the invention. More specifically, it is intended that the invention embrace all alternatives, modifications, and variations of the exemplary embodiments described herein that fall within the spirit and scope of the appended claims or the equivalents thereof. Any element in a claim that does not explicitly state “means for” performing a specified function, or “step for” performing a specific function, is not to be interpreted as a “means” or “step” clause as specified in 35 U.S.C. § 112, ¶ 6. In particular, the use of “step of” in the claims herein is not intended to invoke the provisions of 35 U.S.C. § 112, ¶ 6. Further, the description of the embodiments above does not limit the scope of the claims in any way and the language of the claims has all of its full ordinary meaning.

1. A method of providing a configuration to a programmable device, including:
connecting an electronic storage medium to a configuration system;
establishing at least one configuration for at least one programmable device;
storing the at least one configuration on the electronic storage medium;
disconnecting the electronic storage medium from the configuration system;
connecting the electronic storage medium to the at least one programmable device; and
applying the at least one configuration from the electronic storage medium to the at least one programmable device, wherein the at least one programmable device remains operational and configured if the electronic storage medium remains connected to or is removed from the at least one programmable device after applying the at least one configuration.

2. The method of claim 1 wherein the electronic storage medium includes software for establishing and storing the at least one configuration on the electronic storage medium while connected to the configuration system.

3. The method of claim 2, further including the step of:
updating the software from the Internet, a computer, or a device.

4. The method of claim 1 wherein connecting the electronic storage medium to the configuration system precedes connecting the electronic storage medium to the at least one programmable device.

5. The method of claim 1, further including the steps of:
connecting the electronic storage medium to a second of the at least one programmable devices, wherein the at least one configuration intended for the second of the at least one programmable devices is stored on the electronic storage medium; and
applying the at least one configuration from the electronic storage medium to the second of the at least one programmable devices.

6. The method of claim 5 wherein the at least one configuration is the same for each of the at least one programmable devices.

7. The method of claim 1, further including the step of:
generating results of the application of the at least one configuration from the electronic storage medium to the programmable device.

8. The method of claim 7, further including the step of:
communicating the results via the programmable device.

9. The method of claim 7, further including the steps of:
storing the results to the electronic storage medium;
connecting the electronic storage medium to a results reporting device; and
communicating the results via the results reporting device.

10. The method of claim 1 wherein applying the at least one configuration from the electronic storage medium to the at least one programmable device is automatic upon connecting the electronic storage medium to the at least one programmable device.

11. A programmable device configuration system, including:
an electronic storage medium;
a configuration system connectable to the electronic storage medium; and
at least one programmable device connectable to the electronic storage medium, wherein the at least one programmable device requires the at least one configuration, and wherein the at least one configuration intended for the at least one programmable device is stored on the electronic storage medium.

12. The system of claim 11 wherein the electronic storage medium is a universal serial bus flash drive.

13. The system of claim 11 wherein the at least one programmable device is at least one of a network access point, firewall, network router, or thermostat.

14. The system of claim 11 wherein the configuration system is a computer.

15. The system of claim 11 wherein the electronic storage medium includes software for establishing and storing the at least one configuration on the electronic storage medium while connected to the configuration system.

16. The system of claim 11, further including:
a second of the at least one programmable devices, wherein the at least one configuration intended for the second of the at least one programmable devices is stored on the electronic storage medium.

17. The system of claim 16 wherein the at least one configuration is the same for each of the at least one programmable devices.

18. A method of transferring a configuration from a configuration system to a programmable device, including:
connecting an electronic storage medium to the configuration system;
determining at least one configuration for at least one programmable device, using a superior user interface of the configuration system relative to the programmable device;
storing the at least one configuration on the electronic storage medium;
disconnecting the electronic storage medium from the configuration system;
connecting the electronic storage medium to the at least one programmable device; and
applying the at least one configuration from the electronic storage medium to the at least one programmable device, wherein the at least one programmable device remains operational and configured if the electronic storage medium remains connected to or is removed from the at least one programmable device after applying the at least one configuration.

19. The method of claim 18, further including the step of:
generating results of the application of the at least one configuration from the electronic storage medium to the programmable device.

20. The method of claim 19, further including the steps of:
storing the results to the electronic storage medium;
connecting the electronic storage medium to a results reporting device; and
communicating the results via the results reporting device, using a superior user interface of the results reporting device relative to the programmable device.
